(19) United States
(12) Patent Application Publication
(10) Pub. No.: US 2026/0138026 A1
(43) Pub. Date: May 21, 2026

(54) MULTIMEDIA CONTENT INTERACTION METHOD AND APPARATUS, DEVICE, MEDIUM, AND PROGRAM PRODUCT

(71) Applicant: Tencent Technology (Shenzhen) Company Limited, Shenzhen (CN)

(72) Inventors: Chenda FAN, Shenzhen (CN); Jialu ZHANG, Shenzhen (CN); Yuntao PENG, Shenzhen (CN); Jun ZHANG, Shenzhen (CN); Jianhui LU, Shenzhen (CN); Zexue LI, Shenzhen (CN); Zixia NING, Shenzhen (CN); Yahai WU, Shenzhen (CN); Yuchen ZHANG, Shenzhen (CN)

(21) Appl. No.: 19/451,926

(22) Filed: Jan. 16, 2026

Related U.S. Application Data
(63) Continuation of application No. PCT/CN2024/139084, filed on Dec. 13, 2024.

(30) Foreign Application Priority Data
Jan. 18, 2024 (CN) 202410080333.3

(51) Int. Cl. A63F 13/58; A63F 13/537

(52) U.S. Cl. CPC A63F 13/58; A63F 13/537

(57) ABSTRACT

A multimedia content interaction method is performed by a computer device. The method includes: displaying an information display interface of a first account the information display interface including an avatar display area, the avatar display area including a virtual avatar corresponding to the first account; receiving a first content switching operation; switching, in response to the first content switching operation, the virtual avatar to a multimedia content corresponding to the first account for display in the avatar display area; and playing the multimedia content in the avatar display area.

### CROSS-REFERENCE TO RELATED APPLICATIONS

This application is a continuation application of PCT Patent Application No. PCT/CN2024/139084, entitled “MULTIMEDIA CONTENT INTERACTION METHOD AND APPARATUS, DEVICE, MEDIUM AND PROGRAM PRODUCT” filed on Dec. 13, 2024, which claims priority to Chinese Patent Application No. 202410080333.3, entitled “CONTENT DISPLAY METHOD AND APPARATUS, DEVICE, MEDIUM, AND PROGRAM PRODUCT” and filed on Jan. 18, 2024, all of which are incorporated herein by reference in their entirety.

### FIELD OF THE TECHNOLOGY

Embodiments of this application relate to the field of computer technologies, and in particular, to a multimedia content interaction method and apparatus, a device, a medium, and a program product.

### BACKGROUND OF THE DISCLOSURE

In game application programs, the personal homepage of a player account displays information relevant to the account, such as account's identity information, battle match data within the game, and avatars of virtual characters controlled by the account.

In related technologies, information on the personal homepage is provided by the game system based on basic information inputted by the player and the player's operational performance within the game, categorizing and displaying the information according to a predetermined layout.

However, such information presentation methods exhibit monotony and limited expression dimensions, failing to satisfy diverse needs for homepage display effects.

### SUMMARY

Embodiments of this application provide a multimedia content interaction method and apparatus, a device, a medium, and a program product. The technical solutions are as follows:

According to one aspect, a multimedia content interaction method is performed by a computer device, including:
displaying an information display interface of a first account, the information display interface including an avatar display area, the avatar display area including a virtual avatar corresponding to the first account;
receiving a first content switching operation;
switching the virtual avatar to a multimedia content corresponding to the first account in the avatar display area in response to the first content switching operation; and
playing the multimedia content in the avatar display area.

According to another aspect, a non-transitory computer-readable storage medium is provided, the storage medium having at least one instruction, at least one segment of program, a code set, or an instruction set stored therein, the at least one instruction, the at least one segment of program, the code set, or the instruction set being loaded and executed by a processor to implement the multimedia content interaction method according to any one of the above embodiments of this application.

According to another aspect, a computer device is provided, including computer instructions, the computer instructions being stored in a computer-readable storage medium of the computer device. A processor of the computer device reads the computer instructions from the computer-readable storage medium and executes the computer instructions to cause the computer device to perform the multimedia content interaction method according to any one of the above embodiments.

The technical solutions provided in the embodiments of this application have at least the following beneficial effects:

Through the first content switching operation, the display of the virtual avatar can be switched to the display of the multimedia content in the information display interface, thus increasing the dimension of the display content and enriching the types of information in the information display interface. The multimedia content is played in the avatar display area, thus adding a dynamic display effect based on static display information, and achieving diversified interface display effects. In addition, when a user browses in the information display interface, if the user is interested in the life content or game video content of the first account, the user does not need to switch to the associated account of the first account on the multimedia content platform to view it, thus saving the switching operation between the current program and the multimedia content platform, and improving the efficiency of viewing the multimedia content.

### BRIEF DESCRIPTION OF THE DRAWINGS

FIG. 1 is a schematic diagram of an information display interface according to an exemplary embodiment of this application.

FIG. 2 is a schematic diagram of switching to display a multimedia content in an avatar display area according to an exemplary embodiment of this application.

FIG. 3 is a schematic diagram of a process of displaying a corresponding content in an avatar display area after entering an information display interface according to an exemplary embodiment of this application.

FIG. 4 is a schematic diagram of a process of setting a multimedia content played in an avatar display area according to an exemplary embodiment of this application.

FIG. 5 is a schematic diagram of a process of setting a suspended window content after entering a multimedia content play interface according to an exemplary embodiment of this application.

FIG. 6 is a structural block diagram of a computer device according to an exemplary embodiment of this application.

FIG. 7 is a structural block diagram of a computer system according to an exemplary embodiment of this application.

FIG. 8 is a flowchart of a multimedia content interaction method according to an exemplary embodiment of this application.

FIG. 9 is a schematic diagram of switching a display content by translating according to an exemplary embodiment of this application.

FIG. 10 is a schematic diagram of switching a display content in a scaling mode according to an exemplary embodiment of this application.

FIG. 11 is a schematic diagram of switching a display content in a dragging mode according to an exemplary embodiment of this application.

FIG. 12 is a flowchart of a multimedia content setting method according to an exemplary embodiment of this application.

FIG. 13 is a schematic diagram of displaying a first content in a preview mode according to an exemplary embodiment of this application.

FIG. 14 is a schematic diagram of a display effect of a second content after size cropping in an avatar display area according to an exemplary embodiment of this application.

FIG. 15 is a flowchart of a suspended window play content setting method according to another exemplary embodiment of this application.

FIG. 16 is a schematic diagram of a process of displaying a multimedia content interface by swiping according to an exemplary embodiment of this application.

FIG. 17 is a schematic diagram of a process of triggering display of a multimedia content interface according to an exemplary embodiment of this application.

FIG. 18 is a schematic diagram of displaying a target multimedia content in a suspended window according to an exemplary embodiment of this application.

FIG. 19 is a structural block diagram of a multimedia content interaction apparatus according to an exemplary embodiment of this application.

FIG. 20 is a structural block diagram of a multimedia content interaction apparatus according to another exemplary embodiment of this application.

FIG. 21 is a structural block diagram of a computer device according to an exemplary embodiment of this application.

### DESCRIPTION OF EMBODIMENTS

In game application programs, an information display interface typically includes basic information of an account and system-generated game data, while an avatar display area in the information display interface is configured to display a virtual avatar corresponding to the account.

The type of the virtual avatar includes, but not limited to, a virtual avatar representing an account player himself, and an avatar of a virtual object primarily controlled by the player in a game.

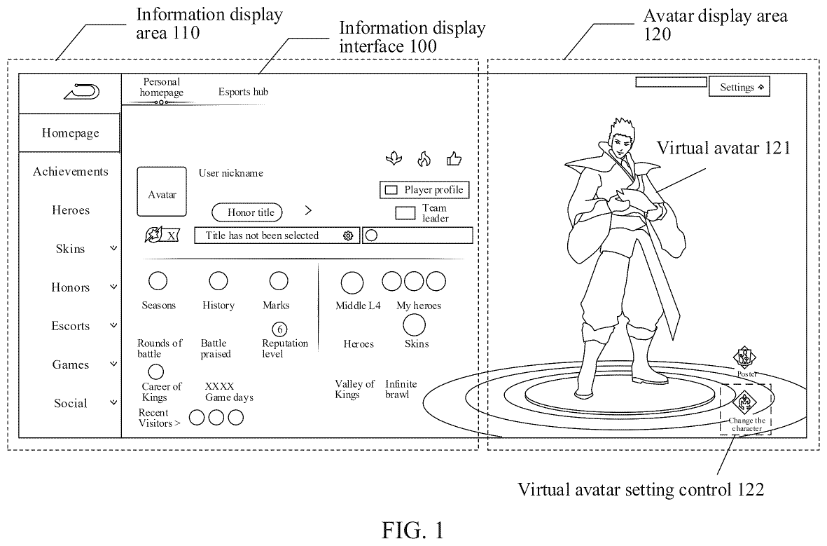

Schematically, as shown in FIG. 1, FIG. 1 is a schematic diagram of an information display interface.

The information display interface 100 includes an information display area 110 and an avatar display area 120. A content displayed in the information display area 110 includes, but not limited to, a nickname of a player, an avatar of the player, and a battle match data in a historical time period. The avatar display area 120 is configured for displaying a virtual avatar 121.

However, the information displayed in the information display interface is generated by a system based on the personal account information inputted by the player and the battle performance of the player in the game, and is statically displayed in a certain layout. The type and expression dimension of the information are limited, which cannot meet the needs of diversified interface display effects.

This application provides a multimedia content interaction method, which can solve the problem that the type of the content and information displayed in the information display interface is limited. The method may be applied to at least one of the following scenarios:
(1) Game scenario: game application programs, and platforms or web pages capable of providing gaming functionalities, such as virtual scene-based application programs. In the game scenario, a game application program includes a player information display interface. The player information display interface displays battle achievement information generated in a historical game playing process, player personal information, virtual avatar display, and the like. The method provided in this embodiment of this application enables switching the virtual avatar displayed in a virtual avatar display area to a multimedia content for display, such as video or audio contents customized by the player, or video or audio contents published by the player through associated accounts on other platforms, based on the virtual avatar display area.
(2) Social scenario: social application programs, and platforms or web pages providing social functionalities, such as application programs offering online chatting communication. In the social application scenario, at least one of the following positions may be used as an avatar display area for displaying the virtual avatar of the user: 1) user profile introduction interface; and 2) chatting interface between users. Taking a chatting interface as an example, during communication between at least two users in the chatting interface, an avatar display area is shown in the chatting interface. The avatar display area displays each user's virtual avatar, e.g., a user A's virtual avatar a. In the method provided in this embodiment of this application, during displaying of the virtual avatar in the avatar display area of a chatting dialog box, the virtual avatar can be switched to display a multimedia content, such as a video or audio content customized by the user, or a video or audio content published by the user through associated accounts on other platforms.
(3) Information sharing platform: a user may upload a customized content to an information sharing platform and view a content uploaded by any other user from the information sharing platform, and so on. In the information sharing platform scenario, the user can set the corresponding virtual avatar and display the user's virtual avatar in at least one of the following positions of the information sharing platform: 1) user information introduction interface; and 2) information sharing content published by the user. Taking the display of the virtual avatar in the information sharing content published by the user as an example, the information sharing content published by the user includes an avatar display area. When any other user views the information sharing content on the information sharing platform, he may perform a switching operation to switch the virtual avatar displayed in the virtual avatar display area to a multimedia content for display, such as a video or audio content customized by the user, or a video or audio content published by the user through associated accounts on other platforms.

In some embodiments, taking the multimedia content interaction method being applied to a game application program as an example, the display content is switched in the avatar display area to the multimedia content to add a dynamic display effect based on static information, thus achieving diversified interface display effects.

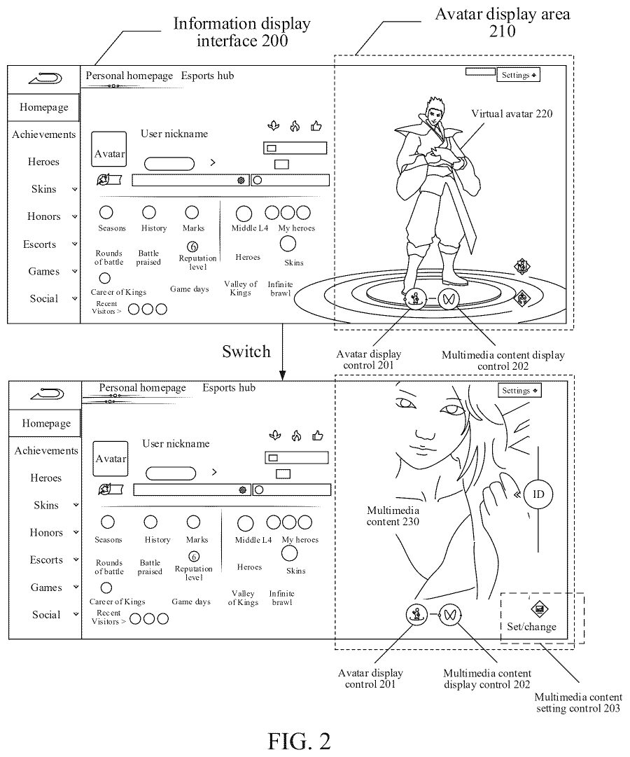

Schematically, as shown in FIG. 2, FIG. 2 is a schematic diagram of switching to display a multimedia content in an avatar display area. The information display interface 200 includes an avatar display area 210. The avatar display area 210 corresponds to an avatar display control 201 and a multimedia content display control 202. By default, or when the avatar display control 201 is triggered, a virtual avatar 220 is displayed in the avatar display area 210. When the multimedia content display control 202 is triggered, a multimedia content 230 is displayed in the avatar display area 210. Taking switching from the virtual avatar 220 to the multimedia content 230 as an example, after triggering the multimedia content display control 202, the multimedia content 230 set by a player account in a historical time period is played in the avatar display area 210.

The type of the multimedia content 230 includes, but not limited to, a video content, a motion picture content, a picture content, and an audio content.

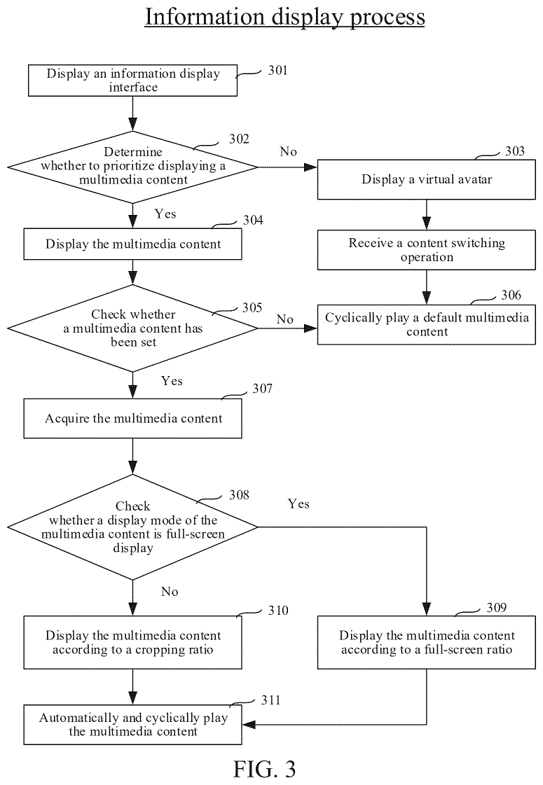

FIG. 3 is a schematic diagram of a process of displaying a corresponding content in an avatar display area after entering an information display interface. An information display process includes the following operations:
301: display an information display interface. The information display interface includes an avatar display area. The avatar display area is configured for displaying a virtual avatar and a multimedia content. The multimedia content includes a playable content with a certain duration. In some embodiments, when the multimedia content is implemented as a picture content, the picture content is displayed through a dynamic effect such as flipping or scaling. Player's operations in the historical time period are recorded and the corresponding operation data are transmitted to a terminal.
302: determine whether to prioritize displaying a multimedia content. The terminal determines whether to prioritize displaying the multimedia content in the avatar display area according to the operation data.
303: when the operation data indicate that displaying the multimedia content is not prioritized, display a virtual avatar.
304: when the operation data indicate that displaying the multimedia content is prioritized, display the multimedia content.
305: determine whether the multimedia content has been set. Whether the multimedia content has been set in the historical time period is checked.
306: when no multimedia content has been set in the historical time period, cyclically play a default multimedia content. The default multimedia content may be any multimedia content, such as a multimedia content with the highest play volume in the multimedia content platform, or a multimedia content set by the system.

In some embodiments, when the terminal receives a content switching operation after displaying of a virtual avatar in the avatar display area, the content displayed in the avatar display area is switched to the multimedia content.
307: when a multimedia content has been set in the historical time period, acquire the multimedia content. A server transmits a content identification (ID) of the multimedia content and the display mode of the multimedia content to the terminal, where the display mode of the multimedia content refers to whether the display size of the multimedia content needs to be cropped when the multimedia content is played.

The terminal acquires the multimedia content through a software development kit (SDK) according to the received content ID.
308: check whether the display mode of the multimedia content is full-screen display. Whether the multimedia content is displayed in a full screen is checked according to the received display mode of the multimedia content.
309: when the display mode is full-screen display, display the multimedia content according to a full-screen ratio. The full-screen ratio refers to a ratio obtained by adaptively adjusting the size of the multimedia content itself and the size of the avatar display area. During full-screen display, the avatar display area is filled with the multimedia content.
310: when the display mode is cropped display, display the multimedia content according to a cropping ratio. The cropping ratio is a ratio obtained by manually cropping the size of the multimedia content by the user.
311: automatically and cyclically play the multimedia content.

In some embodiments, the player may set or change the multimedia content played in the avatar display area, such as setting the multimedia content for a first time, or changing a first multimedia content played in the avatar display area to a second multimedia content.

Schematically, as shown in FIG. 2, the avatar display area 210 includes a multimedia content setting control 203. By triggering of the multimedia content setting control 203, the multimedia content 230 may be set or changed for the first time. In some embodiments, the multimedia content setting control 203 is continuously displayed in the avatar display area 210, or the multimedia content setting control 203 is displayed in the avatar display area 210 after receiving a switching operation when displaying the virtual avatar 220, where the switching operation is configured for indicating switching to display the multimedia content.

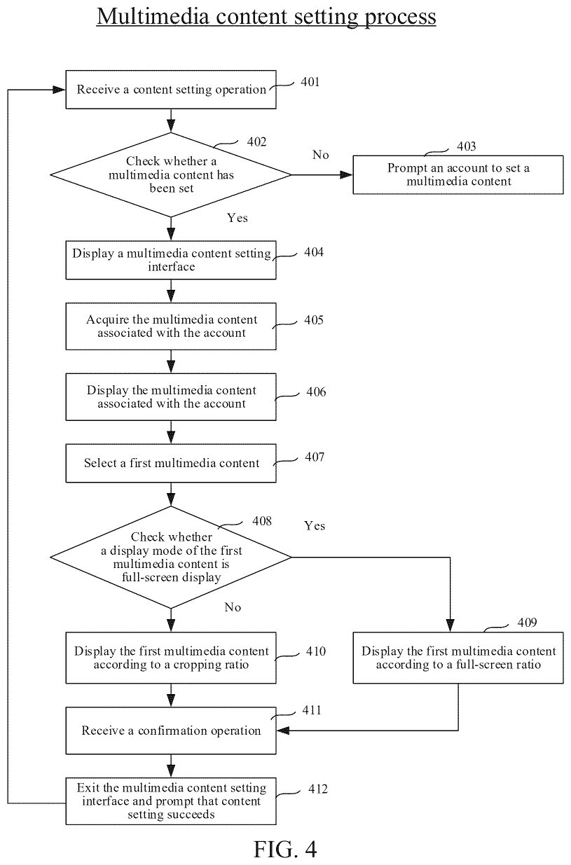

FIG. 4 is a schematic diagram of a process of setting a multimedia content played in an avatar display area. A multimedia content setting process includes the following operations:
401: receive a content setting operation. For example, the avatar display area corresponds to a content setting control, and a trigger operation on the content setting control is received.
402: check whether a multimedia content has been set. Ways for the player to set the multimedia content include, but not limited to, (1) acquiring a multimedia content corresponding to a second account associated with a first account (referring to the player account) and setting it as a multimedia content displayed in the avatar display area, where the multimedia content corresponding to the second account includes a multimedia content uploaded on a multimedia content platform by the second account; (2) acquiring and setting a multimedia content through functions such as photographing, screen shooting, and screen recording provided by the terminal; and (3) acquiring and setting a multimedia content stored locally on the terminal. The server will record whether the player has set the multimedia content in the historical time period and whether the second account associated with the first account has uploaded the multimedia content on the multimedia content platform, and transmit record data to the terminal. The record data is configured for indicating whether the multimedia content setting interface can be displayed.
403: when no multimedia content has been set, prompt an account to set a multimedia content. The terminal prompts the player to associate the accounts to acquire the multimedia content corresponding to the second account, or prompts the player to use the second account to upload the multimedia content on the multimedia content platform.
404: when a multimedia content has been set, display a multimedia content setting interface. The player may set or change the multimedia content displayed in the avatar display area through the multimedia content setting interface.
405: acquire the multimedia content associated with the account.
406: display the multimedia content associated with the account. The terminal acquires the associated multimedia content associated with the player account and displays it as a candidate multimedia content in the multimedia content setting interface. If the multimedia content is a video content or any other content with a certain duration, the candidate multimedia content is displayed in the form of a static frame image list.
407: select a first multimedia content. The terminal receives a selection operation and determines a first multimedia content to be displayed in the avatar display area from the candidate multimedia content.
408: check whether a display mode of the first multimedia content is full-screen display. The terminal determines whether the display mode of the multimedia content is full screen display according to the player's operation.
409: when the display mode is full-screen display, display the multimedia content according to a full-screen ratio.
410: when the display mode is not full-screen display, display the first multimedia content according to a cropping ratio. In some embodiments, when the display mode is not full-screen display, the display mode is implemented as cropped display. If it is cropped display, the multimedia content is displayed according to a cropping ratio.
411: receive a confirmation operation.
412: exit the multimedia content setting interface and prompt that content setting succeeds. The player sets the display mode of the multimedia content and confirms it. The terminal exits the multimedia content setting interface and prompts the player that content setting succeeds. After the multimedia content is successfully set, when the player opens the information display interface, the set multimedia content will be automatically played in the avatar display area, or when the virtual avatar in the avatar display area is switched to display the multimedia content, the set multimedia content will be automatically played.

In some embodiments, the multimedia content not only can be played in the avatar display area of the information display interface, but also can be displayed in a suspended mode on the terminal interface. At this time, the player can, when controlling the virtual object to perform actions or play games in the virtual scene, watch the multimedia content in a suspended window.

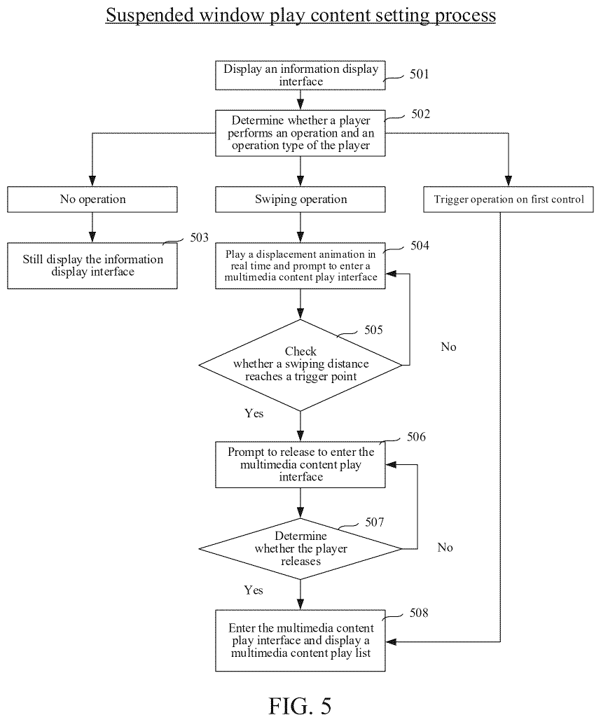

FIG. 5 is a schematic diagram of a process of setting a suspended window content after entering a multimedia content play interface. A suspended window play content setting process includes the following operations:
501: display an information display interface. In some embodiments, after displaying the information display interface, the terminal captures player's operation gestures in real time.
502: determine whether a player performs an operation and an operation type of the player.
503: when the player does not perform an operation, the terminal still displays the information display interface. When the player triggers an operation on a first control corresponding to the multimedia content play interface, the terminal will display the multimedia content play interface, where the multimedia content play interface includes a multimedia content play list, which includes at least one multimedia content to be played.
504: when the player performs a swiping operation, the terminal plays a displacement animation in real time and prompts to enter the multimedia content play interface. The displacement animation refers to an animation that gradually displays the multimedia content play interface by translating. In a play process of the displacement animation, an image occupied by the information display interface in the terminal screen is scaled down, and an image occupied by the multimedia content play interface in the terminal screen is scaled up.
505: check whether a swiping distance corresponding to the swiping operation reaches a trigger point. The trigger point corresponds to a distance threshold. The swiping distance exceeding the trigger point refers to that the swiping distance reaches the distance threshold. When the distance threshold is reached, the terminal displays prompt information to prompt the player to release to enter the multimedia content play interface. If the swiping distance does not exceed the trigger point, the displacement animation is continuously played.
506: when the swiping distance exceeds the trigger point, the terminal prompts to release to enter the multimedia content play interface.
507: the terminal determines whether the player releases.
508: when the player releases, enter the multimedia content play interface and display the multimedia content play list. The terminal plays an interface transition animation and displays the multimedia content play interface. The interface transition animation refers to a transitional animation played during switching of the interface displayed on the terminal from the information display interface to the multimedia content play interface. When the player does not release, the terminal will continue to prompt the player to release to enter the multimedia content play interface.

In some embodiments, when a trigger operation on the first control is received, the terminal executes the operations of entering the multimedia play interface and displaying the multimedia content play list.

In summary, the method provided in this application can switch the content displayed in the avatar display area to the multimedia content set by the player account for display, increasing the dimension of the display content, and enriching the types of information in the information display interface. The multimedia content is played in the avatar display area, thus adding a dynamic display effect based on static display information, and achieving diversified interface display effects.

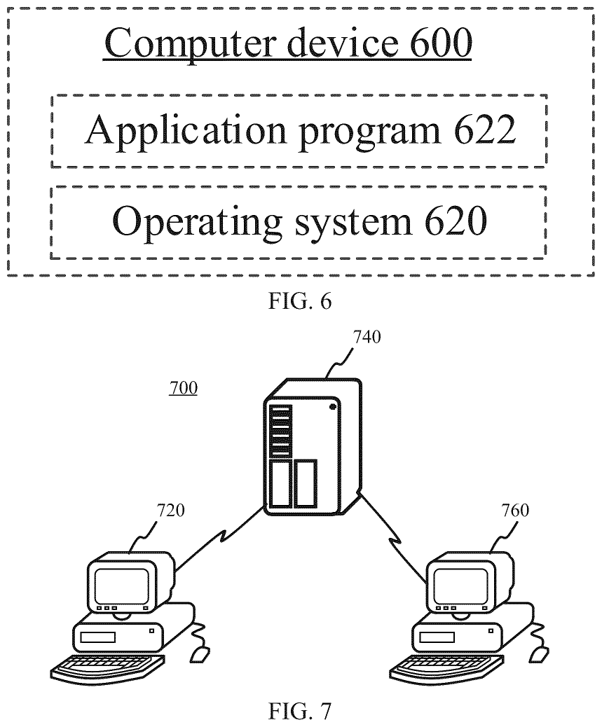

FIG. 6 is a block diagram of a structure of a computer device according to an exemplary embodiment of this application. A computer device 600 includes an operating system 620 and an application program 622. The operating system 620 is basic software provided for the application program 622 to perform secure access to computer hardware.

The application program 622 is an application program supporting a virtual scene. In some embodiments, the application program 622 is an application program supporting a three-dimensional virtual scene. The application program 622 may be any one of a virtual reality application program, a three-dimensional map program, a TPS (third-person shooter) game, an FPS (first-person shooter) game, an MOBA (multiplayer online battle arena) game, an SLG (simulation game), and a party casual game. The application program 622 may be a single-player application program, such as a single-player three-dimensional game program; or may be a network-connected application program.

FIG. 7 shows a structural block diagram of a computer system according to an exemplary embodiment of this application. A computer system 700 includes a first device 720, a server 740, and a second device 760.

An application program supporting a virtual scene is installed and run on the first device 720. The application program may be any one of a virtual reality application program, a three-dimensional map program, a TPS game, an FPS game, an MOBA game, an SLG, and a party casual game. The first device 720 is a device used by a first user. The first user uses the first device 720 to control a primarily controlled virtual object in the virtual scene to perform an action. The action includes, but not limited to, at least one of body posture adjustment, walking, running, jumping, and attacking. Exemplarily, the primarily controlled virtual object is a primarily controlled virtual character, such as a simulated character role or a cartoon character role.

The first device 720 is connected to the server 740 by using a wireless network or a wired network.

The server 740 includes at least one of one server, multiple servers, a cloud computing platform, and a virtualization center. The server 740 is configured to provide a backend service for an application program supporting a three-dimensional virtual scene. In some embodiments, the server 740 undertakes main computing work, and the first device 720 and the second device 760 undertake secondary computing work. Alternatively, the server 740 undertakes secondary computing work, and the first device 720 and the second device 760 undertake main computing work. Alternatively, the server 740, the first device 720, and the second device 760 perform collaborative computing by using a distributed computing architecture.

In some embodiments, the application programs installed on the first device 720 and the second device 760 are the same, or the application programs installed on the two devices are the same type of application programs of different control system platforms. The first device 720 may generally refer to one of multiple devices, and the second device 760 may generally refer to one of multiple devices. In this embodiment, description is made by using only the first device 720 and the second device 760 as an example. Device types of the first device 720 and the second device 760 are the same or different. In the following embodiments, description will be made by taking the device being a desktop computer as an example.

In some embodiments, the first user may view the information display interface of the second user in the application program through the application program installed on the first device 720, and view the multimedia content played in the information display interface. The second user may view the information display interface of the first user in the application program through the application program installed on the second device 760, and view the multimedia content played in the information display interface.

The server 740 may be implemented as a physical server or as a cloud server in the cloud. In some embodiments, when the server 740 is implemented as a cloud server, the program corresponding to the virtual scene may be a cloud game.

In some embodiments, the method provided by this embodiment of this application may be applied to cloud gaming scenarios to complete the computation of data logic in the game process through the cloud server, while the terminal is responsible for displaying the game interface.

In some embodiments, the server 740 may also be implemented as a node in a blockchain system.

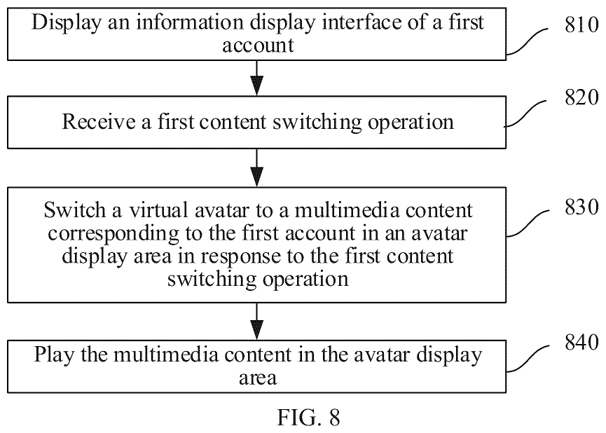

Based on the above noun introduction and application scenarios, the multimedia content interaction method provided in this application will be described. The method is executed by a computer device. The method may be executed separately by a server or a terminal, or may be executed jointly by a server and a terminal. In this embodiment of this application, description is made by taking the method being executed by a terminal as an example. As shown in FIG. 8, FIG. 8 is a flowchart of a multimedia content interaction method according to an exemplary embodiment of this application. The method includes the following operations:
Operation 810: display an information display interface of a first account.

The information display interface includes an avatar display area, and the avatar display area is configured for displaying a virtual avatar corresponding to the first account. The information display interface is an interface used in an application program for displaying login account related information. Typically, the information display interface is implemented as a user introduction interface, role introduction interface, or the like.

In some embodiments, the account currently logged in by the computer device is the first account. Alternatively, the account currently logged in by the computer device is another account. When the computer device currently logs in the first account, the computer device can not only display the information display interface, but also edit or modify the information in the information display interface. When the computer device currently logs in other accounts, the computer device can only view the information display interface.

Schematically, as shown in FIG. 1, the avatar display area 120 is configured for displaying a virtual avatar 121.

In some embodiments, the type of the virtual avatar corresponding to the first account includes, but not limited to, (1) a virtual avatar configured for representing the first account, such as a virtual avatar customized by a player to which the first account belongs, or a virtual avatar generated by a system for the first account; and (2) an avatar of a virtual object controlled by the first account.

The virtual avatar corresponding to the first account may be a three-dimensional or two-dimensional avatar, and the virtual avatar in the avatar display area may be a static image or an animation that is executing an action. In some embodiments, by receiving a trigger operation on the virtual avatar, the static virtual avatar is made to perform a corresponding action or play a voice and audio of the virtual avatar. It can enhance the expressive power of the virtual avatar in the avatar display area from both visual and auditory perspectives.

In some embodiments, the first account corresponds to multiple virtual avatars, and the avatar display area may display the multiple virtual avatars simultaneously or selectively display some of the multiple virtual avatars.

Displaying the multiple virtual avatars simultaneously in the avatar display area can increase the richness of the displayed image and provide timely information on the virtual avatars owned by the first account. Displaying only some virtual avatars in the avatar display area can highlight the virtual avatar in the information display interface, thus improving the sense of presence of the virtual avatar in the information display interface.

In some embodiments, when only one virtual avatar is displayed in the avatar display area, the virtual avatar displayed in the avatar display area may be changed to improve the degree of freedom of the player in setting the display of the virtual avatar, thus replacing the virtual avatar to maintain the freshness of the display content while ensuring the highlighting of the virtual avatar.

For example, the first account corresponds to 2 virtual avatars, namely a first virtual avatar and a second virtual avatar. When only the first virtual avatar is displayed in the avatar display area, it may be changed to the second virtual avatar.

As shown in FIG. 1, after receiving the trigger operation on the virtual avatar setting control 122, the virtual avatar 121 may be changed.
Operation 820: receive a first content switching operation.

The first content switching operation is configured for switching a display content in the avatar display area. The first content switching operation includes at least one of operation forms such as clicking/tapping operation, swiping operation, gravity pressing operation, and dragging operation. In some embodiments, the first content switching operation is an operation performed in the avatar display area; alternatively, the first content switching operation is an operation performed in the information display interface; alternatively, the first content switching operation is an operation performed on a physical key of the computer device; alternatively, the first content switching operation is a motion control operation performed on the computer device, such as an operation of shaking a mobile phone.
Operation 830: switch the virtual avatar to a multimedia content corresponding to the first account in the avatar display area in response to the first content switching operation.

In some embodiments, the multimedia content is a content set by the first account for the avatar display area; alternatively, the multimedia content is a content set by the system for the avatar display area; alternatively, the multimedia content is a random content, which is not limited in this embodiment of this application.

The multimedia content may be a content that has a certain duration and can be played. The type of the multimedia content includes, but not limited to, a video content, a motion picture content, a picture content, and an audio content.

In some embodiments, the information display interface includes a switching control corresponding to the avatar display area, and the switching of the display content can be achieved through the switching control.

The virtual avatar is switched to the multimedia content corresponding to the first account in the avatar display area in response to receiving a trigger operation on the switching control.

Displaying the switching control in the information display interface can prompt the player, and guide the player to trigger the switching between the virtual avatar and the multimedia content for display through the control. Through the switching control, the content in the avatar display area can be switched, thus improving the efficiency of content switching.

Schematically, as shown in FIG. 2, the switching control includes an avatar display control 201 and a multimedia content display control 202.

Schematically, when switching the virtual avatar 220 to the multimedia content 230 for display, the corresponding switching control is the multimedia content display control 202, i.e., after receiving the trigger operation on the multimedia content display control 202, switching is performed to display the multimedia content 230 in the avatar display area 210.

In some embodiments, the terminal may switch the content in the avatar display area by receiving the player's swiping operation on the screen. The player has a high degree of freedom when swiping, thus improving the convenience in switching the content.

In some embodiments, the virtual avatar is switched to the multimedia content corresponding to the first account for display in the avatar display area by translating in response to receiving a first swiping operation on the avatar display area.

Schematically, the virtual avatar is swiped out of the avatar display area by translating and the multimedia content corresponding to the first account is swiped into the avatar display area in response to receiving a first swiping operation on the avatar display area.

The first swiping operation corresponds to a first swiping direction.

Exemplarily, the first swiping direction is horizontally rightward. In a swiping process corresponding to the first swiping operation, the virtual avatar translates in the first swiping direction and gradually disappears, and the multimedia content corresponding to the first account translates in the first swiping direction and gradually appears in the avatar display area.

Switching between the virtual avatar and the multimedia content by translating can enhance the expression effect of the interface content, demonstrate the process of switching between the virtual avatar and the multimedia content, and improve the information expression ability. In addition, if the virtual avatar can be restored to the avatar display area by swiping in an opposite direction, translating can guide the user to restore the virtual avatar to the avatar display area by swiping in the opposite direction, resulting in high human-computer interaction efficiency.

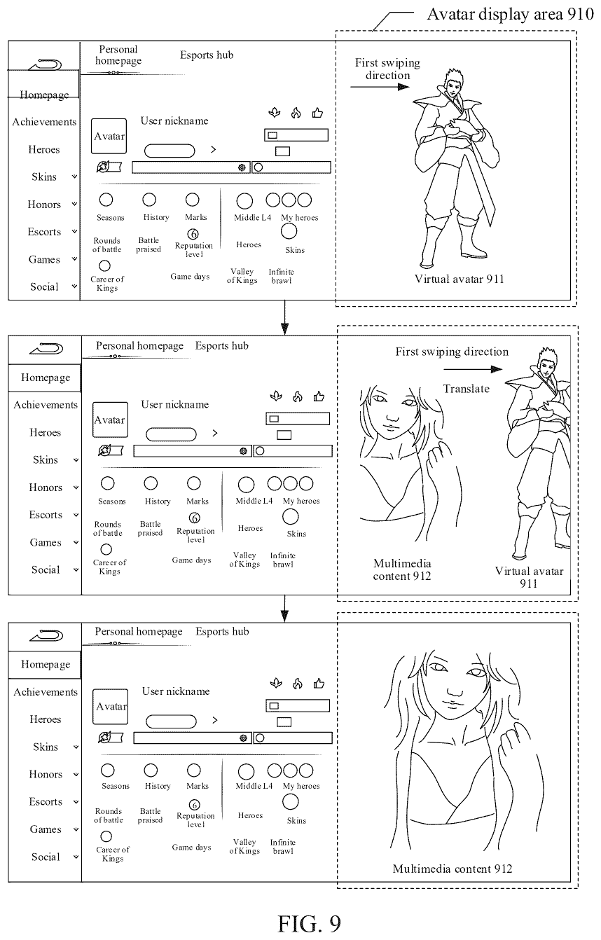

Schematically, as shown in FIG. 9, FIG. 9 is a schematic diagram of switching a display content by translating.

A first swiping operation along a first swiping direction on an avatar display area 910 is received. A virtual avatar 911 is switched to a multimedia content 912. The virtual avatar 911 is swiped out of the avatar display area synchronously with the first swiping operation, while the multimedia content 912 is swiped into the avatar display area synchronously with the first swiping operation.

In some embodiments, the virtual avatar is switched to the multimedia content corresponding to the first account for display in a scaling mode in the avatar display area in response to receiving a first swiping operation on the avatar display area.

Schematically, the virtual avatar is displayed in a scaled-down mode and the multimedia content corresponding to the first account is displayed in a scaled-up mode in the avatar display area in response to receiving the first swiping operation on the avatar display area.

In some embodiments, the virtual avatar is displayed in a scaled-down mode in the avatar display area until the virtual avatar is no longer displayed in the avatar display area; the multimedia content corresponding to the first account is displayed in a scaled-up mode until the display of the multimedia content satisfies a size requirement in the avatar display area. The scaling mode includes displaying the virtual avatar in a scaled-down mode and displaying the multimedia content corresponding to the first account in a scaled-up mode. Embodying the switching process of the display content in the avatar display area through the scaling mode, and reflecting the change before and after content switching in the animation form, can enhance the visual expressiveness of the display and improve the fun when the player switches the content.

Exemplarily, the first swiping direction is horizontally rightward. In a swiping process corresponding to the first swiping operation, the virtual avatar is translated based on the first swiping direction and is gradually scaled down, and the multimedia content corresponding to the first account is translated based on the first swiping direction and is gradually scaled up. The virtual avatar being translated and gradually scaled down based on the first swiping direction may also be understood as a process that the virtual avatar is proportionally scaled down towards an upper right corner, with the upper right corner of the avatar display area as an anchor point; similarly, the multimedia content corresponding to the first account being translated and gradually scaled up based on the first swiping direction may also be understood as a process that the multimedia content is proportionally scaled up towards the upper right corner, with a lower left corner of the avatar display area as an anchor point. The upper right corner and the lower left corner are only exemplary, and any other sampling points may also be used, which are not limited in this embodiment of this application.

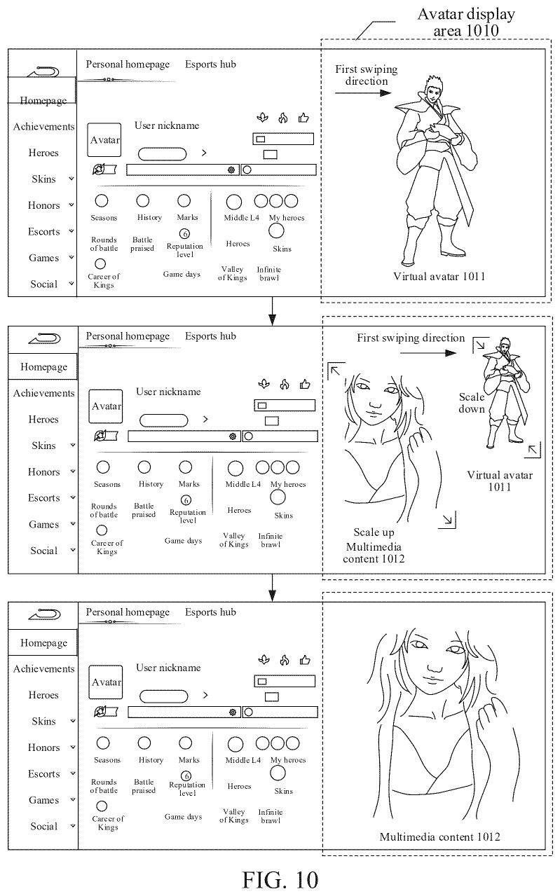

Schematically, as shown in FIG. 10, FIG. 10 is a schematic diagram of switching a display content in a scaling mode. A first swiping operation along a first swiping direction on an avatar display area 1010 is received. A virtual avatar 1011 is switched to a multimedia content 1012. The virtual avatar 1011 is displayed in a scaled-down mode in the avatar display area synchronously with the first swiping operation until it disappears, while the multimedia content 1012 is swiped into the avatar display area synchronously with the first swiping operation.

In some embodiments, the virtual avatar is displayed in a suspended mode on the information display interface and the multimedia content corresponding to the first account is displayed in the avatar display area in response to receiving a dragging operation on the virtual avatar in the avatar display area.

While displaying the multimedia content, the display of the virtual avatar is preserved, thus making the interface display content diversified. Displaying the virtual avatar in a suspended mode while presenting the multimedia content directly in the avatar display area enables a hierarchical visual arrangement with primary and secondary emphasis, thus highlighting the multimedia content.

Exemplarily, after selecting the virtual avatar, it is dragged towards the upper right corner of the terminal screen. When a dragging duration reaches a preset duration or a dragging distance reaches a preset distance, it is released. The scaled-down virtual avatar is displayed at the upper right corner of the avatar display area (release position or preset position of the upper right corner) in a suspended mode, and the multimedia content corresponding to the first account is displayed in the avatar display area.

By default, the virtual avatar is displayed in a permanent suspended mode. When there is a need to cancel the display of the virtual avatar, a corresponding display cancellation target control may be triggered to cancel the display of the virtual avatar.

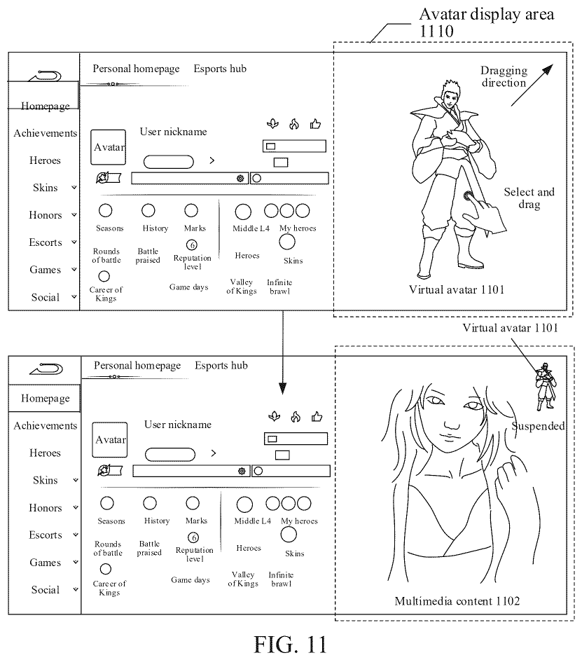

Schematically, as shown in FIG. 11, FIG. 11 is a schematic diagram of switching a display content in a dragging mode.

A dragging operation in any direction on an avatar display area 1110 is received, a virtual avatar 1101 is switched to a multimedia content 1102, and the virtual avatar 1101 is displayed in a suspended mode at a position where it is released during dragging.

In some embodiments, in addition to switching the virtual avatar displayed in the avatar display area to the multimedia content, the multimedia content may also be switched back to the virtual avatar; alternatively, the multimedia content is switched to any other content that may be displayed besides the virtual avatar; alternatively, the display of the avatar display area in the information display interface may be canceled.

In some embodiments, the multimedia content corresponding to the first account is switched to the virtual avatar in the avatar display area by translating in response to receiving a second content switching operation on the avatar display area.

Through a certain type of operation, multiple content switching can be achieved, providing convenience for the player to switch the content back and forth. When the player accidentally touches and switches the content during the operation, the original screen content can be restored in a timely mode, thus improving the efficiency of content switching in the avatar display area and improving the human-computer interaction efficiency.

In some embodiments, the display of the avatar display area in the information display interface is canceled in response to receiving the second content switching operation on the avatar display area.

The display situation of the avatar display area in the information display interface can be determined through one type of operation. After canceling the display of the avatar display area, the space originally occupied by the avatar display area can be configured for displaying other information, thus avoiding crowded arrangement of other information in the information display interface, making the information arrangement in the information display interface more attractive, and improving the space utilization rate of the information display interface.
Operation 840: play the multimedia content in the avatar display area.

In some embodiments, the multimedia content includes a first video content, the first video content has a certain duration and includes multiple video frames, and the video frames correspond to different timestamps of the first video content.

In some embodiments, when the multimedia content includes the video content, the virtual avatar in the avatar display area is switched to the video content. In some embodiments, the video content is set to play automatically.

When it is set to play automatically, the video content will be automatically played in the avatar display area when the information display interface is displayed; alternatively, the information display interface is displayed, and when the virtual avatar is switched to the video content in the avatar display area, it can provide the player with the experience of switching and playing immediately without the need for additional operation, thus saving the operation time of the player.

When it is set to play manually, when the player enters the information interface, a static frame of the multimedia content will be displayed in the avatar display area. After receiving a play operation, the multimedia content will be played again. This way of allowing the player to decide whether to play the multimedia content can save resources consumed by the computer device when playing the multimedia content. When the player does not perform a play operation on the multimedia content, only a static frame is displayed, thus avoiding additional consumption caused by automatic play.

In some embodiments, the volume of the multimedia content during play may also be adjusted. For example, the multimedia content is set to play automatically and mutely, or the multimedia content is set to play automatically with a volume of 50%, and so on. Considering the situation or environment in which the player plays the multimedia content, providing the function of adjusting the play volume can avoid playing the audio of the multimedia content externally without the player's permission and improve the human-computer interaction efficiency.

In some embodiments, taking manual play as an example, the virtual avatar is switched to a cover frame of the first video content in the avatar display area in response to receiving a first content switching operation on the avatar display area, and the cover frame can effectively express the main content of the multimedia content.

The cover frame refers to a static frame that serves as a cover of the first video content, and the cover frame is selected from multiple video frames of the first video content.

In some embodiments, selection criteria for the cover frame include, but not limited to, the following: (1) arranging multiple video frames of the first video content in play order, and using a video frame arranged at a preset place as the cover frame, such as using a first or last video frame of the first video content as the cover frame; (2) when there is a subject in the first video content, using a video frame with the largest proportion of the subject's area in each frame as the cover frame, where the type of the subject includes a human subject, an animal subject, and a virtual object subject; for example, when the first video content includes 10 video frames, there are character A, character B, and animal C in the first video content, and character A appears the most frequently, then considering character A as a subject of the first video content; when character A has the largest area proportion in a 5^{th} video frame, then using the 5^{th} video frame as the cover frame; (3) receiving a selection operation on the cover frame from multiple video frames to determine the cover frame; and (4) when the first video content is a multimedia content uploaded to a multimedia content platform by a second account, and the second account sets a cover for the first video content, using the cover frame set for the first video content when uploaded to the multimedia content platform as the cover frame displayed in the avatar display area of the first video content.

The first video content is played in the avatar display area in response to receiving a play operation on the first video content.

In some embodiments, in order to enhance the display effect of the information display interface on multiple types of information, after determining that the content displayed in the avatar display area is a multimedia content, a background color of the information display interface is adjusted based on the multimedia content, and the adjusted information display interface is displayed to make the display effect of the information display interface more natural. There is a transition between a boundary of the avatar display area and the adjusted information display interface.

In some embodiments, in the display process of the multimedia content, including static and dynamic display processes, the background color of the information display interface is adjusted based on the multimedia content and the adjusted information display interface is displayed. In some embodiments, there is a transition between the boundary of the avatar display area and the adjusted information display interface.

In some embodiments, the process of adjusting the background color will be described by taking the multimedia content including the video content as an example.

Multiple video frames of the video content are acquired, a first color with an appearing frequency that satisfies a frequency requirement in the multiple video frames is determined, a background color of the information display interface is adjusted based on the first color, and the adjusted information display interface is displayed. Using a target color with the highest proportion as the background color can enhance the expressiveness of the multimedia content in the information display interface.

Exemplarily, a color with the highest appearing frequency and the highest total proportion of 20 video frames is determined as the first color.

The video content includes 20 video frames. The most frequently appearing colors are red and yellow, which have appeared in 15 video frames respectively. The total proportion of red in all video frames is 50%. The total proportion of yellow in all video frames is 40%. Therefore, the first color is red.

The background color of the information display interface is adjusted to red. In some embodiments, there will be a gradient effect in the adjusted background color of the information interface.

For example, the red color at the edge of the avatar display area is used as the highest brightness color, rendering with decreasing brightness is performed along the edge of the avatar display area to other areas in the information display interface, and the adjusted information display interface is displayed, where the color of the avatar display area in the information display interface is dark red, the color of the edge in the information display interface is pink, and there is a color transition between the boundary of the avatar display area and the edge of the adjusted information display interface.

By adjusting the background color of the information display interface according to the color of the video frames in the video content in a transitional mode, the fusion between the information display interface and the video content is improved, thus avoiding the problem of poor play effect of the video content due to a style difference between the video content and the information display interface, and improving the attractiveness of the information display interface.

A background color adjustment scheme for the information display interface is determined based on the large area colors in most video frames of the video content, thus improving the consistency between the video color tone and the background color tone of the information display interface in the play process of the video content, and improving the color fusion.

In summary, the method provided in this application, by displaying the information display interface of the first account, using the avatar display area in the information display interface for displaying the virtual avatar corresponding to the first account, and receiving the first content switching operation, can switch the content displayed in the avatar display area to the multimedia content set by the first account for display, increasing the dimension of the display content, and enriching the types of information in the information display interface. The multimedia content is played in the avatar display area, thus adding a dynamic display effect based on static display information, and achieving diversified interface display effects.

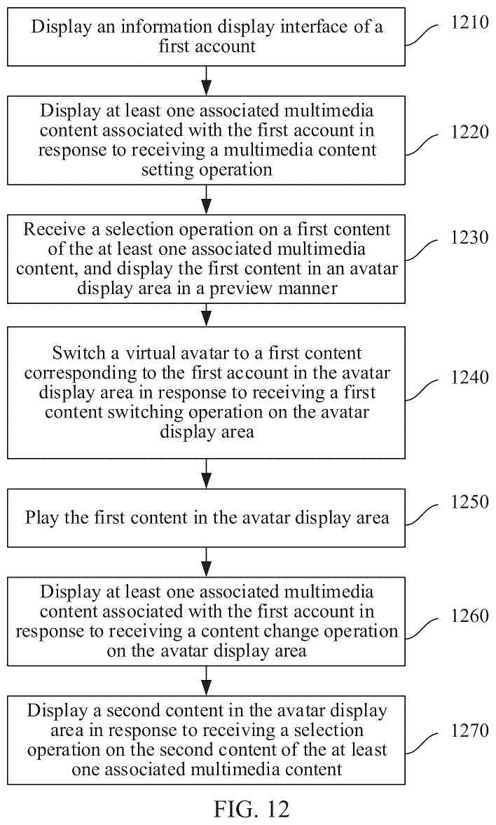

FIG. 12 is a flowchart of a multimedia content setting method according to an exemplary embodiment of this application. The method is executed by a computer device. The method may be executed separately by a server or a terminal, or may be executed jointly by a server and a terminal. In this embodiment of this application, the method is described as being executed by a terminal. As shown in FIG. 12, the method includes the following operations:
Operation 1210: display an information display interface of a first account.

The information display interface includes an avatar display area, and the avatar display area is configured for displaying a virtual avatar corresponding to the first account.
Operation 1220: display at least one associated multimedia content associated with the first account in response to receiving a multimedia content setting operation.

In some embodiments, when the player sets the multimedia content displayed in the avatar display area for the first time, he may choose to use the multimedia content associated with the first account as a candidate display content in the avatar display area, thus improving the player's degree of freedom in setting the multimedia content.

In some embodiments, the first account may perform an association operation with other accounts on other platforms, thus acquiring the multimedia contents corresponding to the accounts on the other platform as the at least one associated multimedia content associated with the first account.

An associated account list is displayed in response to receiving an account association operation. The associated account list includes accounts having an association relationship with the first account.

The association relationship includes at least one of the following: the first account and the other accounts belong to the same user, and there is a social relationship between the first account and the other accounts. The associated account list includes a second account.

At least one multimedia content corresponding to the second account is displayed as the associated multimedia content in response to receiving a selection operation on the second account in the associated account list. The at least one multimedia content corresponding to the second account includes a multimedia content uploaded on a multimedia content platform by the second account.

Exemplarily, the first account belongs to user A, user A has created a second account on a certain multimedia content platform, the first account and the second account belong to the same user, and then there is an association relationship between the first account and the second account.

Therefore, the multimedia content corresponding to the second account refers to the multimedia content uploaded on the multimedia content platform by user A through the second account.

Exemplarily, the first account belongs to user A, user A follows a second account created by user B on a certain multimedia content platform, there is a “follow-followed” relationship of social relationships between the first account and the second account, and then there is an association relationship between the first account and the second account.

Therefore, the multimedia content corresponding to the second account refers to the multimedia content uploaded on the multimedia content platform by user B through the second account.

Exemplarily, the first account has a social relationship with the second account in a game application program, and the type of the social relationship includes, but not limited to, (1) a friend relationship, which means that the first account and the second account are friends with each other; (2) a match relationship, which means that the first account and the second account are enemies, teammates, or the like in a virtual match in the game; (3) a communication relationship, which means that the first account and the second account transmit messages, chat or the like to each other in a historical time period; and (4) a follow relationship, which means that the first account follows the second account, the second account follows the first account, the first account and the second account follow each other, or the like.

Therefore, the multimedia content corresponding to the second account refers to at least one multimedia content played in the information display interface of the second account, or at least one multimedia content uploaded to the game application program by the second account and viewable by other accounts, or multimedia contents uploaded on other multimedia content platforms by the second account.

By associating the first account with associated accounts on other platforms, it is easier for the first account to access the multimedia content shared by the associated accounts on the multimedia content platform. This provides the player with more options when setting the multimedia content, thus allowing the player to select and display the multimedia content based on the preference, and improving the player experience. In addition, by associating the first account with associated accounts on other platforms, and directly acquiring the multimedia content played in the avatar display area from the multimedia contents published by the associated accounts, the player does not need to upload additional multimedia contents for configuration, thus improving the multimedia content configuration efficiency.

In some embodiments, the first account may directly access the multimedia content stored locally on a login terminal as the at least one associated multimedia content associated with the first account.

A multimedia storage content of the first account is displayed in response to receiving a content addition operation. The multimedia storage content includes a multimedia content stored by a login terminal of the first account in a historical time period.

Exemplarily, the avatar display area corresponds to a storage content acquisition control. After the storage content acquisition control is triggered, a local storage folder is displayed. The local storage folder contains locally stored multimedia contents. The locally stored multimedia contents are displayed in a classified mode.

In some embodiments, the first account may also choose to obtain a multimedia content by photographing in real time through functions or components provided by logging in to the terminal, as the associated multimedia content associated with the first account.

A multimedia collection content is displayed in response to receiving a content addition operation. The multimedia collection content includes at least one of a multimedia content obtained by screen-shooting or recording a terminal interface, a multimedia content obtained by photographing through a camera of the terminal, and a multimedia content obtained by recording through a recording component of the terminal.

Exemplarily, a camera component of the terminal may provide a photographing function, and the player to which the first account belongs may obtain a multimedia content, such as a video content or a photo, by photographing through the camera component.

Exemplarily, the terminal may provide a recording function, and the player to which the first account belongs may obtain a multimedia content by recording an image on the terminal screen through the terminal, such as recording an operation video content of the first account in a game application program, recording a video content played on the terminal interface, and screen-shooting an image on the terminal interface to obtain an image.

Exemplarily, the recording component of the terminal may provide a recording function, the player to which the first account belongs obtains an audio content by recording through the recording component, and the type of the audio content includes, but not limited to, a call record, an audio content obtained by recording the content played on the terminal interface, and an audio content obtained by recording a voice of the player belonging to the first account.

By directly acquiring the multimedia content from the first account login device or recording the multimedia content on site by the player, it can provide the player with more ways to acquire the multimedia content. Even if the first account is not associated with any account or the player has not uploaded the multimedia content on the multimedia content platform, the player can still set the multimedia content, thus providing the player with the experience of freely setting the multimedia content and improving the degree of freedom in setting the multimedia content.
Operation 1230: receive a selection operation on a first content of the at least one associated multimedia content, and display the first content in an avatar display area in a preview mode.

The first content is a multimedia content displayed after the first content switching operation indicates switching.

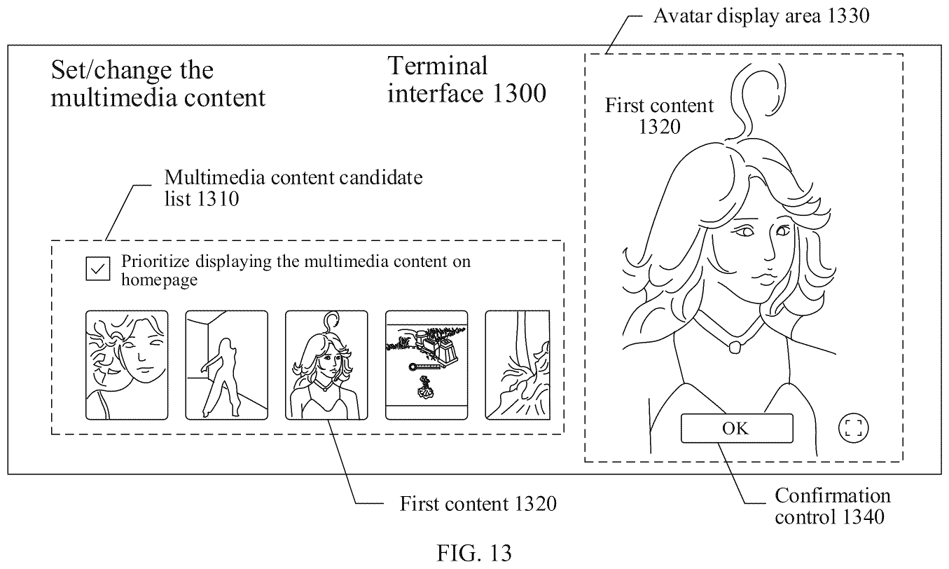

Exemplarily, description will be made by taking the first content being a video content as an example. As shown in FIG. 13, FIG. 13 is a schematic diagram of displaying a first content in a preview mode.

After receiving a multimedia content setting operation, the terminal displays a multimedia content candidate list 1310 on a terminal interface 1300, where the multimedia content candidate list 1310 includes at least one associated multimedia content associated with the first account.

In some embodiments, the associated multimedia contents are all video contents, which are displayed in static frames in the multimedia content candidate list 1310.

After receiving a selection operation on a first content 1320 in the multimedia content candidate list 1310, the terminal displays the first content 1320 in the avatar display area 1330 in a preview mode.

The first content 1320 is a video content, and the video content is automatically played in the avatar display area 1330. When a duration of stay in the avatar display area 1330 is greater than a duration of the first content 1320, the first content 1320 will be played cyclically.

Once the first content 1320 is confirmed, a confirmation control 1340 is triggered to save the settings. When there is a need to switch the virtual avatar in the avatar display area 1330 to the multimedia content, after a switching operation is received, the first content 1320 is displayed in the avatar display area.

In some embodiments, the first content may be any other type of multimedia content, and the method of displaying the first content in a preview mode in the avatar display area may vary depending on the type and duration of the first content.

Exemplarily, when the first content is a picture content, the picture content is directly displayed in a preview mode in the avatar display area.

Exemplarily, when the first content is an audio content, then the audio content is played cyclically in the avatar display area.

Exemplarily, when the first content is an animation content, then the animation content is played cyclically in the avatar display area.
Operation 1240: switch a virtual avatar to a first content corresponding to the first account in the avatar display area in response to receiving a first content switching operation on the avatar display area.

After completing operation 1230, return to the information display interface. When the content displayed in the avatar display area of the information display interface is a virtual avatar, the virtual avatar is switched to a first content in response to the first content switching operation.

The first content refers to a multimedia content set by the first account for the avatar display area in a historical time period.
Operation 1250: play the first content in the avatar display area.

Exemplarily, the first content is a video content, and the terminal receives a first content switching operation. In the avatar display area, the virtual avatar is switched to the first content for display, and the first content is played once or cyclically.
Operation 1260: display at least one associated multimedia content associated with the first account in response to receiving a content change operation on the avatar display area.

The at least one associated multimedia content is a multimedia content published on a multimedia content platform by an associated account associated with the first account.

Both operation 1220 and operation 1260 are configured for setting the multimedia content displayed in the avatar display area, i.e., the at least one associated multimedia content shown in operation 1260 is the same as the at least one associated multimedia content shown in operation 1220.

When setting or changing the multimedia content, the interface displayed on the terminal is the same. Exemplarily, it is the same as the interface shown in FIG. 13.
Operation 1270: display a second content in the avatar display area in response to receiving a selection operation on the second content of the at least one associated multimedia content.

Operations performed in operation 1270 and operation 1230 are the same. The first content and the second content may be the same multimedia content or different multimedia contents.

Through the content change operation, the first content in the avatar display area is switched to the second content, thus improving the efficiency of setting and modifying the multimedia content in the avatar display area, and improving the human-computer interaction efficiency.

In some embodiments, after selecting the associated multimedia content to be played in the avatar display area, the associated multimedia content may also be edited.

In some embodiments, an editing area corresponding to the second content is displayed in response to receiving a selection operation on the second content. The editing area is configured for editing the second content.

An edited second content is displayed in the avatar display area in response to receiving an editing operation on the second content. The operation type of the editing operation includes at least one of size cropping, special effect addition, volume adjustment, and subtitle addition.

Providing the player with an editing function for the multimedia content can enable the player to perform secondary processing on the multimedia content according to the preference, enhance the performance of the associated multimedia content in the avatar display area, meet the need of the player to customize the multimedia content, and improve the player experience.

Exemplarily, a size cropping operation on the second content is received. The size cropping operation is configured for cropping the size of the associated multimedia content to be displayed in the avatar display area.

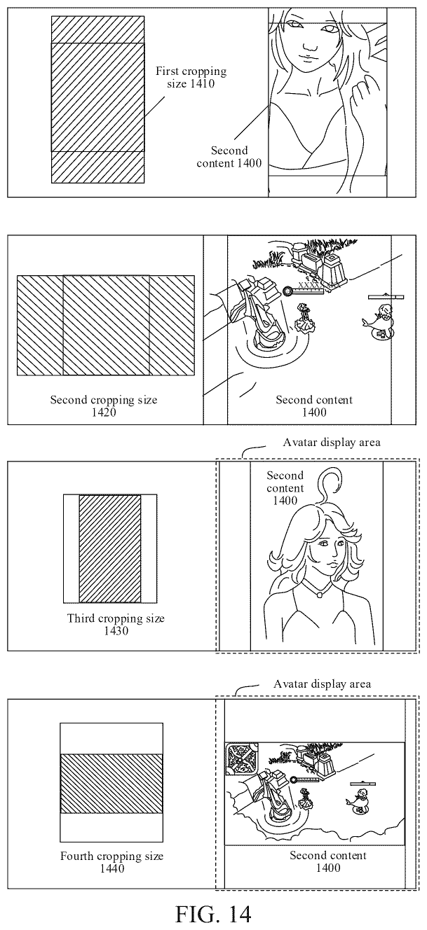

As shown in FIG. 14, FIG. 14 is a schematic diagram of a display effect of a second content after size cropping in an avatar display area.

Taking a second content 1400 being a video content an example, a first cropping size 1410 is configured for displaying in a scaled-down mode the second content 1400 in a portrait orientation; a second cropping size 1420 is configured for displaying in a scaled-down mode the second content 1400 in a landscape orientation; a third cropping size 1430 is configured for filling edges of the second content 1400 in a portrait orientation, so that the second content 1400 in a portrait orientation matches the size of the avatar display area; and a fourth cropping size 1440 is configured for filling edges of the second content 1400 in a landscape orientation, so that the second content 1400 in a landscape orientation matches the size of the avatar display area.

The above several cropping sizes are only for exemplary description, and the player may also customize the cropping size when cropping the associated multimedia content, which is not limited in this embodiment.

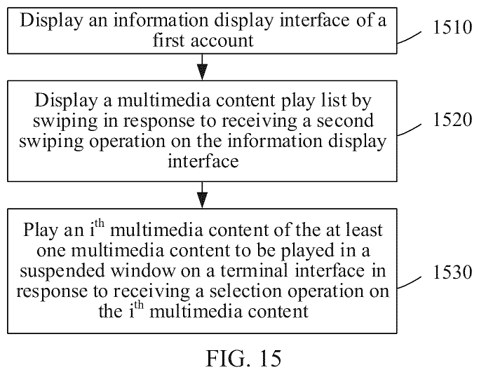

In some embodiments, the multimedia content not only can be played in the avatar display area of the information display interface, but also can be displayed in a suspended mode on the terminal interface. At this time, the player can, when playing the game, watch the multimedia content in a suspended window. The multimedia content played in the suspended window may be determined from the at least one associated multimedia content corresponding to the first account. FIG. 15 is a flowchart of a suspended window play content setting method according to an exemplary embodiment of this application. The method is executed by a computer device. The method may be executed separately by a server or a terminal, or may be executed jointly by a server and a terminal. In this embodiment of this application, description is made by taking the method being executed by a terminal as an example. As shown in FIG. 15, the method includes the following operations:
Operation 1510: display an information display interface of a first account.

The information display interface includes an avatar display area, and the avatar display area is configured for displaying a virtual avatar corresponding to the first account.

In some embodiments, the avatar display area in the information display interface may also be configured for displaying a multimedia content corresponding to the first account.

In some embodiments, in addition to playing the multimedia content in the avatar display area of the information display interface, the multimedia content may also be played directly in a multimedia content play interface, or the selected multimedia content may be played in a suspended window.
Operation 1520: display a multimedia content play list by swiping in response to receiving a second swiping operation on the information display interface.

The second swiping operation corresponds to a second swiping direction. The multimedia content play list includes at least one multimedia content to be played.

In a swiping process, a swiping animation is correspondingly displayed, and the swiping animation is configured for representing the appearance of the multimedia content play list, thus enhancing the visual expression effect.

In some embodiments, the terminal receives a second swiping operation on the information display interface, and based on the swiping distance of the second swiping operation on the information display interface, displays the multimedia content play list by swiping. After the second swiping operation is completed (i.e., the player releases), it enters the multimedia content play interface.

The multimedia content play interface includes a multimedia content play list. At least one multimedia content to be played in the multimedia content play list is the at least one associated multimedia content associated with the first account.

Exemplarily, the at least one associated multimedia content refers to a multimedia content uploaded on a multimedia content platform by a second account having an association relationship with the first account.

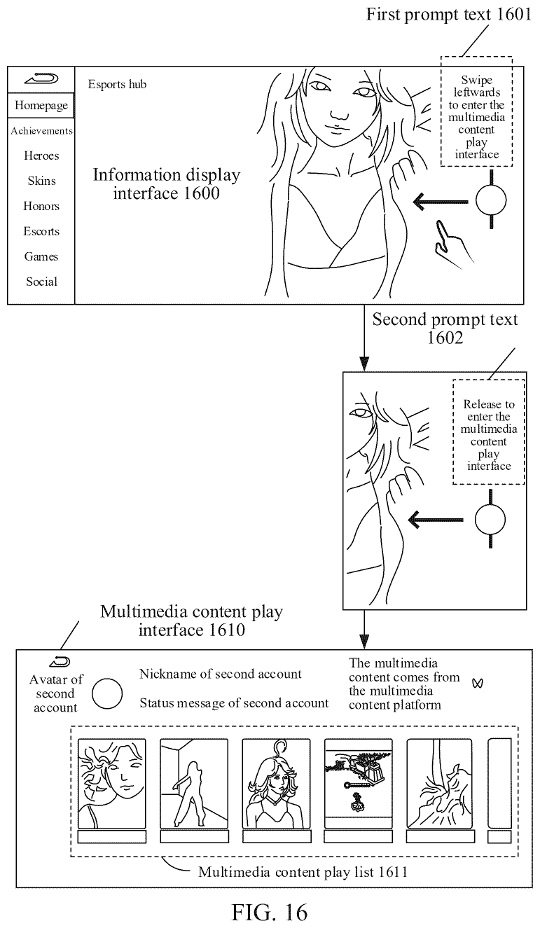

Schematically, as shown in FIG. 16, FIG. 16 is a schematic diagram of a process of displaying a multimedia content interface by swiping.

When a second swiping operation is received on an information display interface 1600 and a second swiping direction of the second swiping operation is horizontally leftward, a multimedia content play interface 1610 is displayed by swiping from right to left.

In a swiping process, a first prompt text 1601 “Swipe leftwards to enter the multimedia content play interface” is displayed, prompting the player to continuously swipe.

When a swiping distance of the second swiping operation reaches a preset distance threshold, a second prompt text 1602 “Release to enter the multimedia content play interface” is displayed, prompting the player to release and end the second swiping operation to display the multimedia content play interface 1610.

The multimedia content play interface 1610 includes a multimedia content play list 1611. The multimedia content play list 1611 includes at least one multimedia content to be played.

Exemplarily, the at least one multimedia content to be played in the multimedia content play list 1611 is a video content, and each multimedia content to be played is displayed in the multimedia content play list 1611 in the form of a static frame.

Exemplarily, the multimedia content to be played included in the multimedia content play list 1611 is a multimedia content uploaded on a multimedia content platform by a second account associated with the first account. The multimedia content play interface 1610 further includes relevant information about the second account, such as second account's avatar, nickname, and status message.

Through a swiping operation, the player may switch from a current page to the multimedia content play interface that includes the multimedia content, thus simplifying the player's operation when switching the page. In the swiping process, different text information is provided for prompting based on the swiping distance, thus allowing the player to understand the progress of current page switching in time and further determine whether the current swiping operation can be ended, prompting the player to release in time to achieve page switching, and improving the human-computer interaction efficiency.

Each multimedia content to be played corresponds to multiple video frames, and only a video frame that serves as a cover of the multimedia content to be played is displayed in the multimedia content play list.

Exemplarily, the multimedia content play list includes 15 multimedia contents to be played, where a first multimedia content to be played includes a total of 50 video frames, and a 25^{th} video frame is used as a cover frame for displaying the first multimedia content to be played in the multimedia content play list.

In some embodiments, when the at least one multimedia content to be played in the multimedia content play list is a video content, each multimedia content to be played may also be played directly and mutely in the multimedia content play list.

In some embodiments, the information display interface includes a play interface target control, and by receiving a trigger operation on the play interface target control, it can also directly enter the multimedia content play interface and display the multimedia content play list.

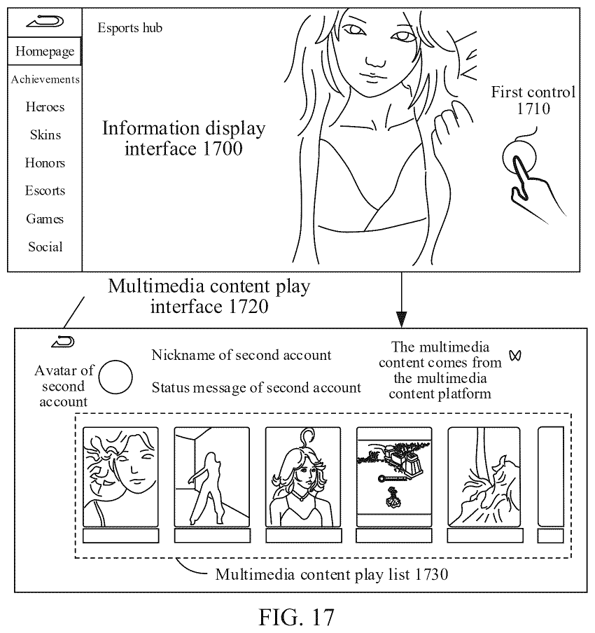

Schematically, as shown in FIG. 17, FIG. 17 is a schematic diagram of a process of displaying a multimedia content interface in a triggering mode.

The information display interface 1700 includes a play interface first control 1710. After triggering the play interface first control 1710, a multimedia content play interface 1720 is directly displayed. The multimedia content play interface 1720 includes a multimedia content play list 1730.

The above methods of swiping to enter the multimedia content play interface and triggering to enter the multimedia content play interface are only exemplary, and in some embodiments, it may also be implemented through other methods. When entering the multimedia content play interface through a swiping operation, the swiping operation may be performed on the information display interface, or on any interface provided by an application program, which is not limited in this embodiment.
Operation 1530: play an i^{th} multimedia content of the at least one multimedia content to be played in a suspended window on a terminal interface in response to receiving a selection operation on the i^{th} multimedia content, where i is a positive integer.

Exemplarily, the multimedia content play list includes 6 multimedia contents to be played and arranged in a certain order, and a 4^{th} multimedia content is determined as a target multimedia content. When playing the target multimedia content in a suspended window, the size of the suspended window, and the position of the suspended window on the terminal interface may be set by the player.

For example, when the suspended window is triggered, a control for adjusting the size of the suspended window is displayed, and the size of the suspended window may be changed by triggering the control. Alternatively, the size of the suspended window is changed by dragging an edge of the suspended window. Alternatively, when the terminal is a device with a touch function, the size of the suspended window may be scaled with two fingers. For example, the suspended window is dragged to change the position of the suspended window, and a position at the end of the dragging operation is a target position of the suspended window.

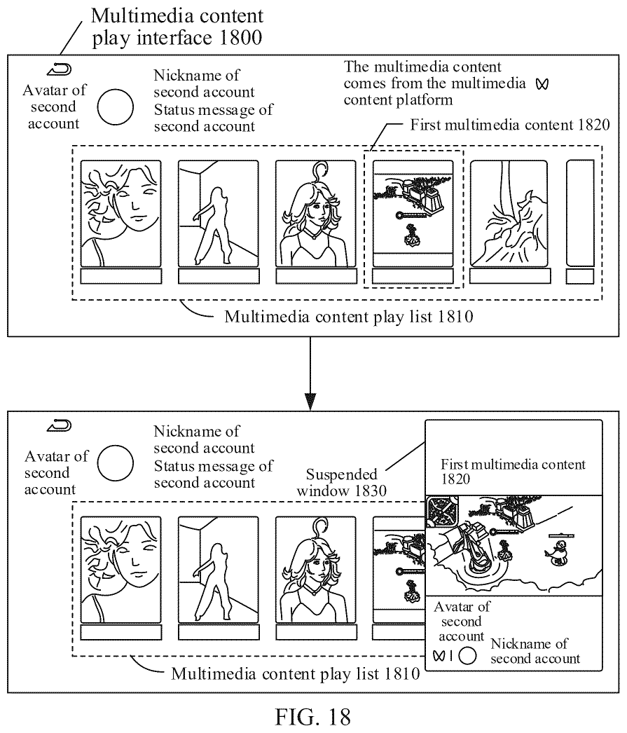

Schematically, as shown in FIG. 18, FIG. 18 is a schematic diagram of a process of displaying a target multimedia content in a suspended window. The multimedia content play interface 1800 includes a multimedia content play list 1810. The multimedia content play list 1810 includes multiple multimedia contents to be played. After selecting a target multimedia content 1820, a suspended window 1830 is displayed, and the target multimedia content 1820 is played in the suspended window 1830.

In some embodiments, when the player wishes to change the multimedia content played in the suspended window and does not exit the multimedia content play interface at this time, the player may select any other multimedia content for replacement. For example, when the multimedia content play list includes a first multimedia content and a second multimedia content, and the player selects the first multimedia content at a first time 10:00:00 without exiting the multimedia content play interface, the first multimedia content is played in the suspended window; when the player selects the second multimedia content at a second time 10:11:00, the suspended window replaces the first multimedia content with the second multimedia content and plays it.

In some embodiments, after setting the multimedia content to be played in the suspended window, when the player exits the multimedia content play interface, the suspended window is permanently displayed and plays a target multimedia content.

When it is expected to stop playing the content in the suspended window or it is expected to cancel the display of the suspended window, it may also be implemented by performing a corresponding operation on the suspended window or triggering a corresponding control.

In some embodiments, when the player expects to change the multimedia content played in the suspended window and has already exited the multimedia content play interface at this time, the player may still return to the multimedia content play interface by swiping or triggering a play interface target control, so as to change the play content in the suspended window. Alternatively, the play content in the suspended window may be changed by triggering the display of the suspended window and a content change control corresponding to the suspended window. Alternatively, the play content in the suspended window may be changed by triggering the suspended window multiple times within a preset duration.

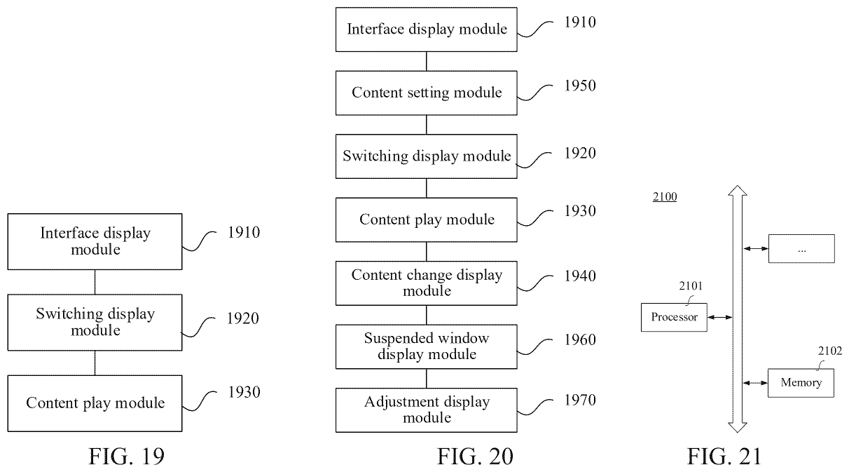

FIG. 19 is a structural block diagram of a multimedia content interaction apparatus according to an exemplary embodiment of this application. As shown in FIG. 19, the apparatus includes:
an interface display module 1910, configured to display an information display interface of a first account, the information display interface including an avatar display area, the avatar display area being configured for displaying a virtual avatar corresponding to the first account;
a switching display module 1920, configured to receive a first content switching operation and switch the virtual avatar to a multimedia content corresponding to the first account in the avatar display area in response to the first content switching operation; and
a content play module 1930, configured to play the multimedia content in the avatar display area.

In an exemplary embodiment, the information display interface includes a switching control; and
the switching display module 1920 is further configured to switch the virtual avatar to the multimedia content corresponding to the first account in the avatar display area in response to receiving a trigger operation on the switching control.

In an exemplary embodiment, the switching display module 1920 is further configured to swipe the virtual avatar out of the avatar display area by translating and swipe the multimedia content corresponding to the first account into the avatar display area in response to receiving a first swiping operation on the avatar display area; or display the virtual avatar in a scaled-down mode and display the multimedia content corresponding to the first account in a scaled-up mode in the avatar display area in response to receiving the first swiping operation on the avatar display area.

In an exemplary embodiment, the switching display module 1920 is further configured to display the virtual avatar in a suspended mode on the information display interface and display the multimedia content corresponding to the first account in the avatar display area in response to receiving a dragging operation on the virtual avatar in the avatar display area.

In an exemplary embodiment, the multimedia content includes a first video content;
the switching display module 1920 is further configured to switch the virtual avatar to a cover frame of the first video content in the avatar display area in response to the first content switching operation; and
the content play module 1930 is further configured to play the first video content in the avatar display area in response to receiving a play operation.

In an exemplary embodiment, the multimedia content displayed in the avatar display area includes a first content.

As shown in FIG. 20, the apparatus further includes:
a content change display module 1940, configured to display at least one associated multimedia content associated with the first account in response to receiving a content change operation, the at least one associated multimedia content being a multimedia content published on a multimedia content platform by an associated account associated with the first account; and display a second content in the avatar display area in response to receiving a selection operation on the second content of the at least one associated multimedia content.

In an exemplary embodiment, the content change display module 1940 is further configured to display an editing area corresponding to the second content in response to receiving a selection operation on the second content, where the editing area is configured for editing the second content; and play an edited second content in the avatar display area in response to receiving an editing operation on the second content, the editing operation including at least one of size cropping, special effect addition, volume adjustment, and subtitle addition.

In an exemplary embodiment, the apparatus further includes:
a content setting module 1950, configured to display at least one associated multimedia content associated with the first account in response to receiving a multimedia content setting operation; and receive a selection operation on the first content of the at least one associated multimedia content, and display the first content in the avatar display area in a preview mode, where the first content is a multimedia content displayed after the first content switching operation indicates switching.

In an exemplary embodiment, the content setting module 1950 is further configured to display an associated account list in response to receiving an account association operation, the associated account list including accounts having an association relationship with the first account; and display at least one multimedia content corresponding to a second account as the associated multimedia content in response to receiving a selection operation on the second account in the associated account list, the at least one multimedia content corresponding to the second account including a multimedia content uploaded on a multimedia content platform by the second account.

In an exemplary embodiment, the content setting module 1950 is further configured to display a multimedia storage content of the first account in response to receiving a content addition operation, the multimedia storage content including a multimedia content stored by a login terminal of the first account in a historical time period; or display a multimedia collection content in response to receiving the content addition operation, the multimedia collection content including at least one of a multimedia content obtained by screen-shooting or recording a terminal interface, a multimedia content obtained by photographing through a camera of the terminal, and a multimedia content obtained by recording through a recording component of the terminal.

In an exemplary embodiment, the apparatus further includes:
a suspended window display module 1960, configured to display a multimedia content play list by swiping in response to receiving a second swiping operation on the information display interface, the multimedia content play list including at least one multimedia content to be played; and play an i^{th} multimedia content of the at least one multimedia content to be played in a suspended window on a terminal interface in response to receiving a selection operation on the i^{th} multimedia content, where i is a positive integer.

In an exemplary embodiment, the switching display module 1920 is further configured to switch the multimedia content corresponding to the first account to the virtual avatar in the avatar display area by translating in response to receiving a second content switching operation; or cancel display of the avatar display area in the information display interface in response to receiving the second content switching operation.

In an exemplary embodiment, the apparatus further includes:
an adjustment display module 1970, configured to adjust, based on the multimedia content, a background color of the information display interface and display the adjusted information display interface in a display process of the multimedia content.

In an exemplary embodiment, the adjustment display module 1970 is further configured to acquire multiple video frames of the video content, determine a first color with an appearing frequency that satisfies a frequency requirement in the multiple video frames, adjust a background color of the information display interface based on the first color, and display the adjusted information display interface.

In summary, the multimedia content interaction apparatus provided in this application, by displaying the information display interface of the first account, using the avatar display area in the information display interface for displaying the virtual avatar corresponding to the first account, and receiving the first content switching operation, can switch the content displayed in the avatar display area to the multimedia content set by the first account for display, increasing the dimension of the display content, and enriching the types of information in the information display interface. The multimedia content is played in the avatar display area, thus adding a dynamic display effect based on static display information, and achieving diversified interface display effects.

FIG. 21 is a structural block diagram of a computer device 2100 according to an exemplary embodiment of this application. The computer device 2100 may be a smart phone, a tablet computer, a moving picture experts group audio layer III (MP3) player, a moving picture experts group audio layer IV (MP4) player, a notebook computer, or a desktop computer. The computer device 2100 may further be referred to as another name such as user equipment, a portable terminal, a laptop terminal, or a desktop terminal.

Generally, the computer device 2100 includes a processor 2101 and a memory 2102.

The processor 2101 may include one or more processing cores, such as a 4-core processor or an 8-core processor. The processor 2101 may be implemented in at least one hardware form of digital signal processing (DSP), a field-programmable gate array (FPGA), and a programmable logic array (PLA). The processor 2101 may also include a main processor and a coprocessor. The main processor is a processor configured to process data in an awake state, and is also referred to as a central processing unit (CPU). The coprocessor is a low power consumption processor configured to process data in a standby state. In some embodiments, the processor 2101 may be integrated with a graphics processing unit (GPU). The GPU is configured to render and draw content that needs to be displayed on a display screen. In some embodiments, the processor 2101 may further include an artificial intelligence (AI) processor. The AI processor is configured to process computing operations related to machine learning.

The memory 2102 may include one or more computer-readable storage media. The computer-readable storage medium may be non-transient. The memory 2102 may further include a high-speed random access memory and a nonvolatile memory, for example, one or more disk storage devices or flash storage devices. In some embodiments, the non-transient computer-readable storage medium in the memory 2102 is configured to store at least one instruction. The at least one instruction is executed by the processor 2101 to perform the multimedia content interaction method provided in the method embodiment of this application.

In some embodiments, the computer device 2100 further includes other components. Those skilled in the art may understand that the structure shown in FIG. 21 does not constitute a limitation to the computer device 2100, which may include more or fewer components than those shown in the figure, or some components may be combined, or a different component deployment may be adopted.

In some embodiments, the computer-readable storage medium may include: a read-only memory (ROM), a random access memory (RAM), a solid state drive (SSD), and an optical disc. The RAM may include a resistance random access memory (ReRAM) and a dynamic random access memory (DRAM). The sequence numbers of the foregoing embodiments of this application are merely for description purpose but do not imply the preference among the embodiments.

An embodiment of this application further provides a computer device. The computer device includes a processor and a memory. The memory has at least one instruction, at least one segment of program, a code set, or an instruction set stored therein. The at least one instruction, the at least one segment of program, the code set, or the instruction set is loaded and executed by the processor to implement the multimedia content interaction method according to any one of the above embodiments of this application.

An embodiment of this application further provides a non-transitory computer-readable storage medium. The storage medium has at least one instruction, at least one segment of program, a code set, or an instruction set stored therein. The at least one instruction, the at least one segment of program, the code set, or the instruction set is loaded and executed by a processor to implement the multimedia content interaction method according to any one of the above embodiments of this application.

An embodiment of this application further provides a computer program product or a computer program. The computer program product or the computer program includes computer instructions. The computer instructions are stored in a non-transitory computer-readable storage medium. A processor of a computer device reads the computer instructions from the computer-readable storage medium and executes the computer instructions to cause the computer device to perform the multimedia content interaction method according to any one of the above embodiments. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

What is claimed is:

1. A multimedia content interaction method, executed by a computer device, comprising:
displaying an information display interface of a first account, the information display interface comprising an avatar display area, the avatar display area including a virtual avatar corresponding to the first account;
receiving a first content switching operation;
switching the virtual avatar to a multimedia content corresponding to the first account in the avatar display area in response to the first content switching operation; and
playing the multimedia content in the avatar display area.

2. The method according to claim 1, wherein the switching the virtual avatar to a multimedia content corresponding to the first account in the avatar display area in response to the first content switching operation comprises:
switching the virtual avatar to the multimedia content corresponding to the first account in the avatar display area in response to receiving a trigger operation on a switching control in the information display interface.

3. The method according to claim 1, wherein the switching the virtual avatar to a multimedia content corresponding to the first account in the avatar display area in response to the first content switching operation comprises:
swiping the virtual avatar out of the avatar display area followed by translating and swiping the multimedia content corresponding to the first account into the avatar display area in response to receiving a first swiping operation on the avatar display area;
displaying the virtual avatar in a scaled-down mode followed by displaying the multimedia content corresponding to the first account in a scaled-up mode in the avatar display area in response to receiving the first swiping operation on the avatar display area; or
displaying the virtual avatar in a suspended mode on the information display interface and displaying the multimedia content corresponding to the first account in the avatar display area in response to receiving a dragging operation on the virtual avatar in the avatar display area.

4. The method according to claim 1, wherein the switching the virtual avatar to a multimedia content corresponding to the first account in the avatar display area in response to the first content switching operation comprises:
switching the virtual avatar to a cover frame of a first video content in the avatar display area in response to the first content switching operation; and
playing the first video content in the avatar display area in response to receiving a play operation.

5. The method according to claim 1, wherein the method further comprises:
displaying at least one associated multimedia content associated with the first account in response to receiving a content change operation, the at least one associated multimedia content being a multimedia content published on a multimedia content platform by an associated account associated with the first account; and
displaying a second content in the avatar display area in response to receiving a selection operation on the second content of the at least one associated multimedia content.

6. The method according to claim 5, wherein the method further comprises:
displaying an editing area corresponding to the second content in response to receiving the selection operation on the second content, the editing area being configured for editing the second content; and
playing an edited second content in the avatar display area in response to receiving an editing operation on the second content, the editing operation comprising at least one of size cropping, special effect addition, volume adjustment, and subtitle addition.

7. The method according to claim 1, wherein the method further comprises:
displaying at least one associated multimedia content associated with the first account in response to receiving a multimedia content setting operation; and
receiving a selection operation on a first content of the at least one associated multimedia content, and displaying the first content in the avatar display area in a preview mode, wherein the first content is a multimedia content displayed after the first content switching operation indicates switching.

8. The method according to claim 7, wherein the displaying at least one associated multimedia content associated with the first account in response to receiving a multimedia content setting operation comprises:
displaying an associated account list in response to receiving an account association operation, the associated account list comprising accounts having an association relationship with the first account; and
displaying at least one multimedia content corresponding to a second account as the associated multimedia content in response to receiving a selection operation on the second account in the associated account list, the at least one multimedia content corresponding to the second account comprising a multimedia content uploaded on a multimedia content platform by the second account.

9. The method according to claim 7, wherein the displaying at least one associated multimedia content associated with the first account in response to receiving a multimedia content setting operation comprises:
displaying a multimedia storage content of the first account in response to receiving a content addition operation, the multimedia storage content comprising a multimedia content stored by a login terminal of the first account in a historical time period; or
displaying a multimedia collection content in response to receiving the content addition operation, the multimedia collection content comprising at least one of a multimedia content obtained by screen-shooting or recording a terminal interface, a multimedia content obtained by photographing through a camera of the terminal, and a multimedia content obtained by recording through a recording component of the terminal.

10. The method according to claim 1, wherein the method further comprises:
displaying a multimedia content play list in response to receiving a second swiping operation on the information display interface, the multimedia content play list comprising at least one multimedia content to be played; and
playing an i^{th} multimedia content of the at least one multimedia content to be played in a suspended window on a terminal interface in response to receiving a selection operation on the i^{th} multimedia content, where i is a positive integer.

11. The method according to claim 1, wherein after the switching the virtual avatar to a multimedia content corresponding to the first account for display in the avatar display area in response to receiving a first content switching operation on the avatar display area, the method further comprises:
switching the multimedia content corresponding to the first account to the virtual avatar in the avatar display area by translating in response to receiving a second content switching operation; or
canceling display of the avatar display area in the information display interface in response to receiving the second content switching operation.

12. The method according to claim 1, wherein the method further comprises:
adjusting, based on the multimedia content, a background color of the information display interface and displaying an adjusted information display interface in a display process of the multimedia content.

13. The method according to claim 12, wherein the adjusting, based on the multimedia content, a background color of the information display interface and displaying an adjusted information display interface in a display process of the multimedia content comprise:
acquiring a plurality of video frames of a video content and determining a first color with an appearing frequency that satisfies a frequency requirement in the plurality of video frames; and
adjusting the background color of the information display interface based on the first color and displaying the adjusted information display interface.

14. A computer device, comprising a processor and a memory, the memory having at least one segment of program stored therein, and the at least one segment of program, when being loaded and executed by the processor, causing the computer device to implement a multimedia content interaction method including:
displaying an information display interface of a first account, the information display interface comprising an avatar display area, the avatar display area including a virtual avatar corresponding to the first account;
receiving a first content switching operation;
switching the virtual avatar to a multimedia content corresponding to the first account in the avatar display area in response to the first content switching operation; and
playing the multimedia content in the avatar display area.

15. The computer device according to claim 14, wherein the switching the virtual avatar to a multimedia content corresponding to the first account in the avatar display area in response to the first content switching operation comprises:
switching the virtual avatar to the multimedia content corresponding to the first account in the avatar display area in response to receiving a trigger operation on a switching control in the information display interface.

16. The computer device according to claim 14, wherein the switching the virtual avatar to a multimedia content corresponding to the first account in the avatar display area in response to the first content switching operation comprises:
swiping the virtual avatar out of the avatar display area followed by translating and swiping the multimedia content corresponding to the first account into the avatar display area in response to receiving a first swiping operation on the avatar display area;
displaying the virtual avatar in a scaled-down mode followed by displaying the multimedia content corresponding to the first account in a scaled-up mode in the avatar display area in response to receiving the first swiping operation on the avatar display area; or
displaying the virtual avatar in a suspended mode on the information display interface and displaying the multimedia content corresponding to the first account in the avatar display area in response to receiving a dragging operation on the virtual avatar in the avatar display area.

17. The computer device according to claim 14, wherein the switching the virtual avatar to a multimedia content corresponding to the first account in the avatar display area in response to the first content switching operation comprises:
switching the virtual avatar to a cover frame of a first video content in the avatar display area in response to the first content switching operation; and
playing the first video content in the avatar display area in response to receiving a play operation.

18. The computer device according to claim 14, wherein the method further comprises:
displaying at least one associated multimedia content associated with the first account in response to receiving a content change operation, the at least one associated multimedia content being a multimedia content published on a multimedia content platform by an associated account associated with the first account; and
displaying a second content in the avatar display area in response to receiving a selection operation on the second content of the at least one associated multimedia content.

19. The computer device according to claim 14, wherein the method further comprises:
displaying a multimedia content play list in response to receiving a second swiping operation on the information display interface, the multimedia content play list comprising at least one multimedia content to be played; and
playing an i^{th} multimedia content of the at least one multimedia content to be played in a suspended window on a terminal interface in response to receiving a selection operation on the i^{th} multimedia content, where i is a positive integer.

20. A non-transitory computer-readable storage medium, the storage medium having at least one segment of program stored therein, and the at least one segment of program, when being loaded and executed by a processor of a computer device, causing the computer device to implement a multimedia content interaction method including:
displaying an information display interface of a first account, the information display interface comprising an avatar display area, the avatar display area including a virtual avatar corresponding to the first account;
receiving a first content switching operation;
switching the virtual avatar to a multimedia content corresponding to the first account in the avatar display area in response to the first content switching operation; and
playing the multimedia content in the avatar display area.
